(19) United States
(12) Patent Application Publication
(10) Pub. No.: US 2025/0113249 A1
(43) Pub. Date: Apr. 3, 2025

(54) RESOURCE POOLING FOR VIRTUALIZED RADIO ACCESS NETWORK

(71) Applicant: CommScope Technologies LLC, Claremont, NC (US)

(72) Inventors: Arthur J. Barabell, Sudbury, MA (US); Irfaan Ahamed Salahuddeen, Acton, MA (US)

(73) Assignee: CommScope Technologies LLC, Claremont, NC (US)

(21) Appl. No.: 18/715,663

(22) PCT Filed: Dec. 6, 2022
(86) PCT No.: PCT/US2022/081023

§ 371 Date: May 31, 2024

Related U.S. Application Data
(60) Provisional application No. 63/288,786, filed on Dec. 13, 2021.

(51) Int. Cl. H04W 28/08; H04L 41/0897; H04L 43/0876; H04W 28/02

(52) U.S. Cl. CPC H04W 28/08; H04L 41/0897; H04L 43/0876; H04W 28/0215

(57) ABSTRACT

One embodiment is directed to using a set of multi-cell virtual network functions (VNFs) that natively perform baseband processing necessary to provide wireless service to user equipment (UEs) using multiple cells. Respective demand information for each cell is determined. A respective allocation of the one or more resources for each cell is determined based on the demand information for the multiple cells. For each cell scheduling of the respective UEs is performed for that cell with an objective of ensuring that a respective demand for the one or more resources in connection with serving that cell does not exceed the capacity associated with the respective allocation of the one or more resources for that cell and baseband processing necessary to provide respective wireless service via that cell is performed in accordance with the scheduling for that cell. Other embodiments are disclosed.

### CROSS-REFERENCE TO RELATED APPLICATIONS

This application claims the benefit of U.S. Provisional Patent Application Ser. No. 63/288,786, filed on Dec. 13, 2021, entitled “RESOURCE POOLING FOR VIRTUALIZED RADIO ACCESS NETWORK”, the entirety of which is incorporated herein by reference.

### BACKGROUND

Cloud-based virtualization of Fifth Generation (5G) base stations (also referred to as a “gNodeBs” or “gNBs”) is widely promoted by standards organizations, wireless network operators, and wireless equipment vendors. Such an approach can help provide high-availability and scalability as well as addressing other issues in the network.

In general, a distributed 5G gNB can be partitioned into different entities, each of which can be implemented in different ways. For example, each entity can be implemented as a physical network function (PNF) or a virtual network function (VNF) and in different locations within an operator's network (for example, in the operator's “edge cloud” or “central cloud”).

A 5G gNB is typically partitioned into one or more central units (CUs), one or more distributed units (DUs), and one or more radio units (RUs). In this example, each CU is configured to implement the control-plane and user-plane Layer-3 functions for the user equipment (UEs) served by that CU, and each DU is configured to implement, for the UEs served by that DU, the control-plane and user-plane Layer-2 functions as well as some of the control-plane and user-plane Layer-1 functions (also referred to here as the “upper” or “high” Layer-1 or physical layer (PHY) functions). In this example, each RU is configured to implement, for the UEs served by that RU, the control-plane and user-plane Layer-1 functions not implemented by its serving DU (also referred to here as the “lower” or “low Layer-1 or PHY functions) as well as the radio frequency (RF) functions.

Each RU is typically implemented as a physical network function (PNF) and is deployed in a physical location where radio coverage is to be provided. Each DU is typically implemented as a VNF and, as the name implies, is typically distributed and deployed in a distributed manner in the operator's edge cloud. Each CU is typically implemented as a VNF and, as the name implies, is typically centralized and deployed in the operator's central cloud. Each CU can be further partitioned into one or more entities that implement the control-plane functions of the CU (each of which is also referred to here as a “Central Unit-Control Plane” entity (CU-CP)) and one or more entities that implement the user-plane functions of the CU (each of which is referred to here as a “Central Unit-User Plane” entity (CU-UP)).

When deploying a distributed gNB, appropriate capacity planning based on the specific needs of the site is performed and will determine the number of RUs, DUs, and CUs deployed and their respective capacity parameters. However, to more efficiently use limited capital resources, operators typically use some degree of oversubscription at all levels in deploying a distributed gNB. Oversubscription refers to the relationship between the theoretical maximum (peak case) required capacity and the actual deployed capacity for a given resource. Use of oversubscription for a given resource inherently means that the system actual demand will not get satisfied should it exceed the deployed capacity for the resource. In this case, the system is considered to be in an overloaded state. In theory, if the actual deployed capacity for that resource can be scaled dynamically (for example, using cloud and virtualization technology), such overload can be avoided. However, in reality, such dynamic scaling is not perfect due to, for example, the time it takes for the system to adapt to changes in resource needs and the granularity in the resource scaling.

### SUMMARY

In one embodiment, a system to provide wireless service to user equipment (UEs) is disclosed. The system comprises a scalable cloud environment configured to execute a set of multi-cell virtual network functions (VNFs) configured to natively perform baseband processing necessary to provide wireless service to the UEs using multiple cells using one or more resources. The set of multi-cell VNFs is configured to determine respective demand information for each cell that is indicative of a respective demand for the one or more resources in connection with serving that cell. The set of multi-cell VNFs is also configured to determine a respective allocation of the one or more resources for each cell based on the demand information for the multiple cells. The set of multi-cell VNFs is also configured to, for each cell, perform scheduling of the respective UEs for that cell with an objective of ensuring that a respective demand for the one or more resources in connection with serving that cell does not exceed a capacity associated with the respective allocation of the one or more resources for that cell. The set of multi-cell VNFs is also configured to perform baseband processing necessary to provide respective wireless service via that cell in accordance with the scheduling for that cell.

In another embodiment, a method of providing wireless service to user equipment (UEs) using a scalable cloud environment is disclosed. The scalable cloud environment is configured to execute a set of multi-cell virtual network functions (VNFs) configured to natively perform baseband processing necessary to provide wireless service to the UEs using multiple cells using one or more resources. The method comprises determining respective demand information for each cell that is indicative of a respective demand for the one or more resources in connection with serving that cell. The method also comprises determining a respective allocation of the one or more resources for each cell based on the demand information for the multiple cells. For each cell, the method also comprises performing scheduling of the respective UEs for that cell with an objective of ensuring that a respective demand for the one or more resources in connection with serving that cell does not exceed a capacity associated with the respective allocation of the one or more resources for that cell. The method also comprises performing baseband processing necessary to provide respective wireless service via that cell in accordance with the scheduling for that cell.

### BRIEF DESCRIPTION OF THE DRAWINGS

Understanding that the drawings depict only exemplary embodiments and are not therefore considered limiting in scope, the exemplary embodiments will be described with additional specificity and detail through the use of the accompanying drawings, as briefly described below and as specifically described in the detailed description.

FIG. 1 is a block diagram illustrating one exemplary embodiment of a system to provide wireless service to user equipment.

FIGS. 2A-2B are block diagrams illustrating exemplary embodiments to allocating resources to designated units in a multi-cell system.

FIG. 3 is a flow diagram illustrating one exemplary embodiment of a method of providing wireless service to user equipment.

FIGS. 4-7 are block diagrams illustrating exemplary embodiments of usage scenarios of allocating resources by a multi-cell VNF.

FIGS. 8-10 are block diagrams illustrating exemplary embodiments of configuring sets of resource pools to a multi-cell VNF.

In accordance with common practice the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

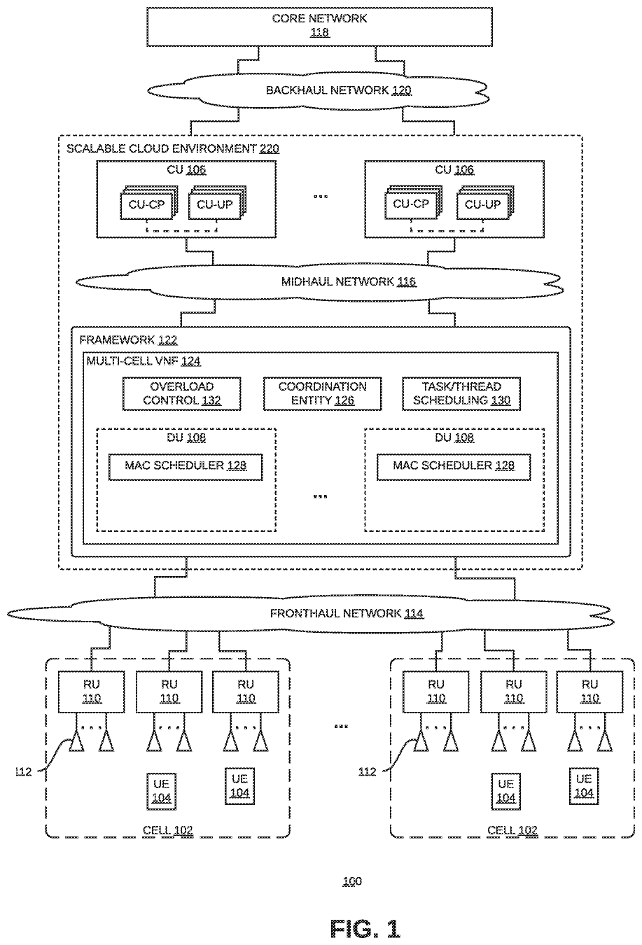

FIG. 1 is a block diagram illustrating one exemplary embodiment of a system 100 in which the techniques described below can be used. The system 100 shown in FIG. 1 implements a respective base station entity for serving each of multiple cells 102. Each such base station entity can also be referred to here as a “base station” or “base station system” (and, which in the context of a fourth generation (4G) Long Term Evolution (LTE) system, may also be referred to as an “evolved NodeB” or “eNodeB” and, in the context of a fifth generation (5G) New Radio (NR) system, may also be referred to as a “gNodeB”).

In general, the system 100 is configured to provide wireless service to various items of user equipment (UEs) 104 served by each cell 102. Unless explicitly stated to the contrary, references to Layer 1, Layer 2, Layer 3, and other or equivalent layers (such as the Physical Layer or the Media Access Control (MAC) Layer) refer to layers of the particular wireless interface (for example, 4G LTE or 5G NR) used for wirelessly communicating with UEs 104 served by each cell 102. Furthermore, it is also to be understood that 5G NR embodiments can be used in both standalone and non-standalone modes (or other modes developed in the future) and the following description is not intended to be limited to any particular mode. Moreover, although some embodiments are described here as being implemented for use with 5G NR, other embodiments can be implemented for use with other wireless interfaces and the following description is not intended to be limited to any particular wireless interface.

In the exemplary embodiment shown in FIG. 1, for each cell 102, the associated system 100 implements one or more centralized units (also referred to as “control units”) (CUs) entities 106, one or more distributed units (DUs) entities 108, and at least one radio unit (also referred to as “remote units”) (RUs) 110. Although FIG. 1 illustrates each cell 102 implementing three RUs 110, more or fewer RUs 110 can be associated with a given cell 102.

Each RU 110 includes or is coupled to a respective set of one or more antennas 112 via which downlink RF signals are radiated to UEs 104 and via which uplink RF signals transmitted by UEs 104 are received.

In this embodiment, for each cell 102, the respective one or more CUs 106 implements the control-plane and user-plane Layer-3 functions for the cell 102, and, for each cell 102, the respective one or more DUs 108 implement the control-plane and user-plane Layer-2 functions. Moreover, the respective one or more DUs 108 implement some of the control-plane and user-plane Layer-1 functions (also referred to here as the “upper” or “high” Layer-1 functions). Other embodiments can be implemented in other ways.

In this embodiment, each RU 110 is configured to implement, for the UEs 104 served by that RU 110, the control-plane and user-plane Layer-1 functions not implemented by the associated DU 108 (also referred to here as the “lower” or “low” Layer-1 functions) as well as the radio frequency (RF) functions.

Each RU 110 can be remotely or proximately located from each of the other RUs 110 serving the associated cell 102 as well as from the CU 106 and DU 108 serving it. RUs 110 associated with one cell 102 can also be remotely or proximately located from RUs 110 associated with another cell 102. The RUs 110 are communicatively coupled to the DU 108 serving the cell 102 via a fronthaul network 114 (for example, using a switched Ethernet network and the Internet Protocol (IP)). The DU 108 is coupled to the CU 106 via a network 116 (also referred to here as a “midhaul” network 116). The CU 106 is coupled to a core network 118 of the associated wireless network operator over an appropriate backhaul 120 (such as the Internet). The physical nodes on which the DUs 108 are implemented include suitable network interfaces to couple those nodes to the fronthaul network 114 in order to facilitate communications between the DUs 108 and the RUs 110. The one or more physical nodes on which the CUs 106 are implemented include suitable network interfaces to couple those nodes to the midhaul network 116 in order to facilitate communications between each CU 106 and the associated one or more DUs 108. The one or more physical nodes on which the CUs 106 are implemented include suitable network interfaces to couple those nodes to the backhaul 120 in order to facilitate communications between the system 100 and the core network 118. In some embodiments, the CU 106 and DU 108 are collocated.

Although FIG. 1 (and the description set forth below more generally) is described in the context of a 5G embodiment in which each logical base station entity is partitioned into a CU 106, DUs 108, and RUs 110 and some physical-layer processing is performed in the DUs 108 with the remaining physical-layer processing being performed in the RUs 110, it is to be understood that the techniques described here can be used with other wireless interfaces (for example, 4G LTE) and with other ways of implementing a base station entity (for example, using a conventional baseband band unit (BBU)/remote radio head (RRH) architecture or a single entity architecture such as a “femtocell”). Accordingly, references to a CU, DU, or RU in this description and associated figures can also be considered to refer more generally to any entity (including, for example, any “base station” or “RAN” entity) implementing any of the functions or features described here as being implemented by a CU, DU, or RU.

Each CU 106, DU 108, and RU 110, and any of the specific features described here as being implemented thereby, can be implemented in hardware, software, or combinations of hardware and software, and the various implementations (whether hardware, software, or combinations of hardware and software) can also be referred to generally as “circuitry,” a “circuit,” or “circuits” that is or are configured to implement at least some of the associated functionality. When implemented in software, such software can be implemented in software or firmware executing on one or more suitable programmable processors (or other programmable device) or configuring a programmable device (for example, processors or devices included in or used to implement special-purpose hardware, general-purpose hardware, and/or a virtual platform). In such a software example, the software can comprise program instructions that are stored (or otherwise embodied) on or in an appropriate non-transitory storage medium or media (such as flash or other non-volatile memory, magnetic disc drives, and/or optical disc drives) from which at least a portion of the program instructions are read by the programmable processor or device for execution thereby (and/or for otherwise configuring such processor or device) in order for the processor or device to perform one or more functions described here as being implemented the software. Such hardware or software (or portions thereof) can be implemented in other ways (for example, in an application specific integrated circuit (ASIC), etc.).

Moreover, each CU 106, DU 108, and RU 110, can be implemented as a physical network function (PNF) (for example, using dedicated physical programmable devices and other circuitry) and/or a virtual network function (VNF) (for example, using one or more general purpose servers (possibly with hardware acceleration) in a scalable cloud environment 220 and in different locations within an operator's network (for example, in the operator's “edge cloud” or “central cloud”). Each VNF can be implemented using hardware virtualization, operating system virtualization (also referred to as containerization), and application virtualization as well as various combinations of two or more the preceding. Where containerization is used to implement a VNF, it may also be referred to as a “containerized network function” (CNF).

For example, in the exemplary embodiment shown in FIG. 1, each RU 110 is implemented as a PNF and is deployed in or near a physical location where radio coverage is to be provided and each CU 106 and DU 108 is implemented using a respective set of one or more VNFs deployed in a distributed manner, with, for example, the CU 106 implemented in an operator's central cloud and the DU 108 in an edge cloud. In this exemplary embodiment, the VNFs used to implement the CU 106 and DU 108 are deployed using a general-purpose containerization or virtualization framework 122 (such as the Kubernetes containerization framework).

Each CU 106, DU 108, and RU 110, and any of the specific features described here as being implemented thereby, can be implemented in other ways.

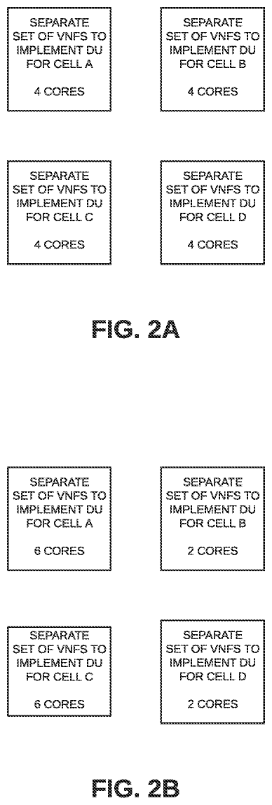

One approach to allocating resources (for example, processing, storage, and/or communication resources) to each DU in a multi-cell system is illustrated in FIGS. 2A-2B. With this approach, a separate set of one or more VNFs is instantiated for each cell served by the multi-cell system, where each such set of one or more VNFs is used to implement on a single DU in order to serve only a single cell. With this approach, resources are allocated on a per-VNF and the allocation is dynamically adjusted as needed in response to changes in demand. In particular, with this per-VNF approach, when the resources allocated to the separate set of VNF instances used to implement one DU are increased, the resources allocated to the respective one or more sets of VNFs instances used to implement one or more other DUs are reduced. In the example shown in FIGS. 2A-2B, respective sets of VNFs are instantiated in order to implement four DUs in order to serve four cells (individually referenced in FIGS. 2A-2B as cell A, cell B, cell C, and cell D). Initially, as shown in FIG. 2A, the resources are allocated on an equal basis (for example, the respective set of VNF instances used to implement each DU is allocated four processing cores). In response to increased loads in cells A and C, as shown in FIG. 2B, the resources allocated to the respective sets of VNFs serving those cells A and C are increased (increasing from four processing cores to six processing cores) while decreasing the resources allocated to the sets of VNFs serving the other cells B and D (decreasing from four processing cores to two processing cores) and maintaining the same overall resource allocation (sixteen processing cores).

Some issues with this per-VNF approach are that it is potentially slow (on the order of seconds, if not longer) to adjust the resource allocation (for example, where the general-purpose container or virtualization framework is used to adjust the resource allocation), coarse in its adjustment (for example, where there are only few adjustment steps that can be implemented), and “on the fly” allocation adjustments may not be possible (for example, where the general-purpose container or virtualization framework does not support allocation adjustments without stopping and restarting the affected VNFs). To address these issues, resource adjustments can be scheduled to occur only during planned service maintenance windows and/or a full-featured redundancy capability could be deployed in order to minimize service disruption during resource adjustments.

An alternative to the per-VNF approach is illustrated in the exemplary embodiment shown in FIG. 1. As shown in FIG. 1, a set of one or more multi-cell VNFs 124 are used to implement multiple DUs 108 that serve the multiple cells 102, where each VNF 124 included in the set is “multi-cell” in that it is configured to natively serve the multiple cells 102. The set of one or more multi-cell VNFs 124 used to implement the multiple DUs 108 to serve the multiple cells 102 is also referred to here as the “multi-cell VNF set.”

In the exemplary embodiment shown in FIG. 1, the multi-cell VNF set used to implement multiple DUs 108 for serving the multiple served cells 102 includes a first subset that are used to implement Layer-1 functions for the cells 102 (which are also referred to here as the Layer-1 multi-cell VNFs 124) and a second subset that are used to implement Layer-2 functions for the cells 102 (which are also referred to here as the Layer-2 multi-cell VNFs 124). In this exemplary embodiment, one Layer-2 multi-cell VNF 124 is used, which implements all Layer-2 functions for the multiple served cells 102. The Layer-2 multi-cell VNF 124 comprises one or more MAC scheduler functions (also referred to here as “MAC schedulers”) 128, where the UEs 104 for each of the multiple served cells 102 is scheduled by at least one of the MAC schedulers 128. In the example shown in FIG. 1, the one Layer-2 multi-cell VNF 124 implements a respective MAC scheduler 128 for each of the multiple cells 102. Also, in this example, one Layer-1 multi-cell VNF 124 is used, which implements all Layer-1 functions for the multiple served cells 102.

The general-purpose containerization or virtualization framework 122 is configured to allocate a fixed amount of resources (for example, processing, storage, and/or communication resources) to the multi-cell VNF set, which is essentially the aggregate or total resource budget for the multiple DUs 108 implemented by that set of multi-cell VNFs 124. The resource usage within the multi-cell VNFs 124 is managed in order to ensure that the sum of the resource usage by the multiple DUs 108 implemented by the set of multi-cell VNFs 124 stays within the fixed amount of resources allocated to that set of multi-cell VNFs 124 by the general-purpose containerization or virtualization framework 122.

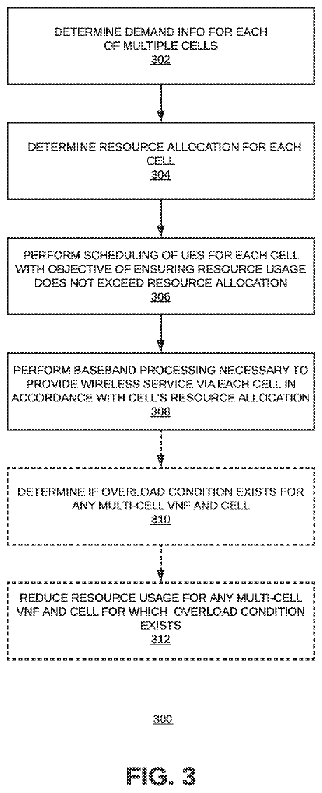

FIG. 3 comprises a high-level flowchart illustrating one exemplary embodiment of a method 300 of providing wireless service to UEs 104. The embodiment of method 300 shown in FIG. 3 is described here as being implemented, at least in part, by the set of multi-cell VNFs 124 that implement the DUs 108 for the base station system 100 described above in connection with FIG. 1, though it is to be understood that other embodiments can be implemented in other ways. For example, at least some of the processing described below in connection with blocks 302 and 304 can be implemented, at least in part, by one or more entities that are not implemented using the multi-cell VNFs 124 (for example, a RAN intelligent controller (RIC)).

The blocks of the flow diagram shown in FIG. 3 have been arranged in a generally sequential manner for ease of explanation; however, it is to be understood that this arrangement is merely exemplary, and it should be recognized that the processing associated with method 300 (and the blocks shown in FIG. 3) can occur in a different order (for example, where at least some of the processing associated with the blocks is performed in parallel and/or in an event-driven manner). Also, most standard exception handling is not described for ease of explanation; however, it is to be understood that method 300 can and typically would include such exception handling. Moreover, one or more aspects of method 300 can be configurable or adaptive (either manually or in an automated manner).

Method 300 comprises determining respective demand information for each of the multiple cells 102 that is indicative of the respective demand for the one or more resources in connection with serving that cell (block 302) and determining a respective allocation of the one or more resources for each cell 102 based on the demand information for the multiple cells 102 (block 304). The demand information can comprise information about past or current demand or usage for each of the multiple served cells 102 and/or can comprise information about expected future demand or usage for each of the multiple served cells 102. Examples of the respective demand information for each cell 102 include information about one or more of: a respective number of active UEs, a respective number of connected UEs, a respective number of scheduled UEs per transmission time interval (TTI), a respective throughput, respective coding rates used, a respective carrier bandwidth, a respective number of constituent carriers used, respective modulation modes used, a respective sub-carrier spacing used, a respective duplexing mode used, a respective slot format used, respective transmission ranks used, a respective number physical resource blocks (PRBs) communicated, a respective bit rate, and a respective number of packets per second. The demand information used for determining the resource allocations can be based on a single reporting period (for example, the most-recent past or future reporting period) or can be based on multiple reporting periods (for example, the usage statistics can be averaged multiple reporting periods). The demand information can be determined in other ways.

In the exemplary embodiment described here in connection with FIG. 1, one or more entities (for example, the MAC schedulers 128 for the multiple cells 102) can be configured to determine the demand information for each cell 102 and communicate the demand information to one or more coordination entities 126. The one or more coordination entities 126 are provided with the total resource budget for the multiple DUs 108 implemented by the set of multi-cell VNFs 124. The total resource budget for the multiple DUs 108 is allocated to the set of multi-cell VNFs 124 by the general-purpose containerization or virtualization framework 122. The resources allocated to the multi-cell VNF set by the general-purpose containerization or virtualization framework 122 can take the form of a set of one or more resource pools. As used here, a “resource pool” refers to a set of resources from which a given multi-cell VNF 124 can be allocated resources on a cell-by-cell basis for use by that multi-cell VNF 124. Each resource pool can include one or more types of resources (for example, processing resources such as processor cores or threads, communication resources such as front-haul bandwidth, and storage resources such as buffer resources). One or more of the resource pools can be dedicated to a single multi-cell VNF 124, in which case resources from that resource pool are only allocated to that single multi-cell VNF 124. One or more of the resource pools can also be shared by two or more multi-cell VNFs 124, in which case resources from that resource pool are allocated among those multi-cell VNFs 124.

The one or more coordination entities 126 use load management techniques to determine respective individual resource allocations for each of the multiple served cells 102 in accordance with each cell's demand (as reflected by its demand information) while also ensuring that the sum of the resource usage by the multiple DUs 108 implemented by the set of multi-cell VNFs 124 stays within the total resource budget. The individual resource allocations allocate resources from the set of one or more resource pools to appropriate multi-cell VNFs 124. For networks that support network slicing, each multi-cell VNF 124 can be dedicated to a different network slice, or a single multi-cell VNF 124 can be shared among multiple network slices.

In one example, the one or more coordination entities 126 allocate resources among the multiple served cells 102 on a pro rata basis based on each cell's demand. After determining each served cell's allocation of the total resource budget, the relevant coordination entity 126 communicates allocation information to the relevant MAC schedulers 128 for that served cell 102.

Also, it may be necessary for the resource allocations to take into account that baseband processing for the cells 102 may be performed in a pipelined manner. That is, baseband processing associated with wirelessly communicating over-the-air with UEs 104 during a given transmission time interval (TTI) may be performed prior to that TTI (in the case of downlink processing) or after that TTI (in the case of uplink processing). Therefore, scheduling decisions made by a MAC scheduler 128 for a given TTI may impact the baseband processing that is performed before and/or after that TTI. Therefore, any change in the resource allocations granted to the cells 102 should take this into account. For example, where the resources allocated to a first cell 102 are increased and the resources allocated to a second cell 102 are reduced, the amount of resources used to perform the baseband processing for the first cell 102 should not be increased until the amount of the resources used to perform the baseband processing for the second cell 102 has been reduced. For example, each MAC scheduler 128 can be configured to use feedback or reports about the current resource usage for the set of resource pools in making scheduling decisions for the associated cell 102.

In the exemplary embodiment shown in FIG. 1, the one or more coordination entities 126 comprises a single central coordination entity 126 that is configured to receive the demand information for the multiple served cells 102 and to allocate resources for all of the multiple served cells 102. It is to be understood, however, that multiple coordination entities 126 can be used. For example, a distributed coordination scheme can be used in which multiple coordination entities 126 are used. In such a distributed coordination scheme, a respective separate coordination entity 126 can be implemented as a part of the MAC scheduler 128 for each served cell 102. Each separate distributed coordination entity 126 can be configured to receive the same demand information for all of the multiple served cells 102 and to allocate resources for the individual served cell 102 with which that coordination entity 126 is associated using the same allocation algorithm as the other distributed coordination entities 126.

The one or more coordination entities 126 and MAC schedulers 128 can communicate with each other using, for example, interprocess communication within the general-purpose containerization or virtualization framework 122.

Method 300 further comprises, for each of the multiple served cells 102, performing scheduling of the respective UEs 104 for that cell 102 e.g., with an objective of ensuring that a respective demand for the one or more resources in connection with serving that cell 102 does not exceed a capacity associated with the respective allocation of the one or more resources for that cell 102 (block 306) and performing baseband processing necessary to provide respective wireless service via that cell 102 in accordance with the scheduling for that cell 102 (block 308).

In the exemplary embodiment described here in connection with FIG. 1, each MAC scheduler 128 is configured to use the respective resource allocation information for the associated cell 102 in performing the scheduling of the UEs 104 with an objective of ensuring that the resource usage resulting from the set of multi-cell VNFs 124 performing the baseband processing necessary to provide wireless service for the associated cell 102 in accordance with the scheduling is less than or equal to that cell's resource allocation.

This can be done on a resource-pool-by-resource-pool basis. For example, each MAC scheduler 128 can be configured to determine, for each resource pool, the resource usage that would result for a given candidate “schedule” and compare that resource usage to the resource allocation provided to the MAC scheduler 128 for that resource pool. If, for a given candidate schedule, the respective resource usage determined for any resource pool exceeds the resource allocation provided to the MAC scheduler 128 for that resource pool, then that candidate schedule is not used. That is, the resource usage resulting from performing the baseband processing necessary to provide wireless service to the scheduled UEs 104 is used as an additional constraint in the scheduling performed by each MAC scheduler 128.

Also, each MAC scheduler 128, when performing the scheduling for a given time transmission interval (TTI), can be configured to take into account the resource usage resulting from performing the baseband processing necessary for that TTI as well any baseband processing that still needs to be performed for any prior TTIs and/or any baseband processing that may need to be performed in any future TTIs.

Moreover, each MAC scheduler 128 can be configured to perform scheduling in an “open loop” manner, in which each MAC scheduler 128 does not use any feedback or reports about the current resource usage for the set of resource pools; instead, each MAC scheduler 128 can configured to estimate the current resource usage for the resource pools and use such estimates in making scheduling decisions for the associated cell 102. Alternatively, each MAC scheduler 128 can be configured to perform scheduling in a “closed loop” manner in which each MAC scheduler 128 uses feedback or reports about the current resource usage for the set of resource pools in making scheduling decisions for the associated cell 102.

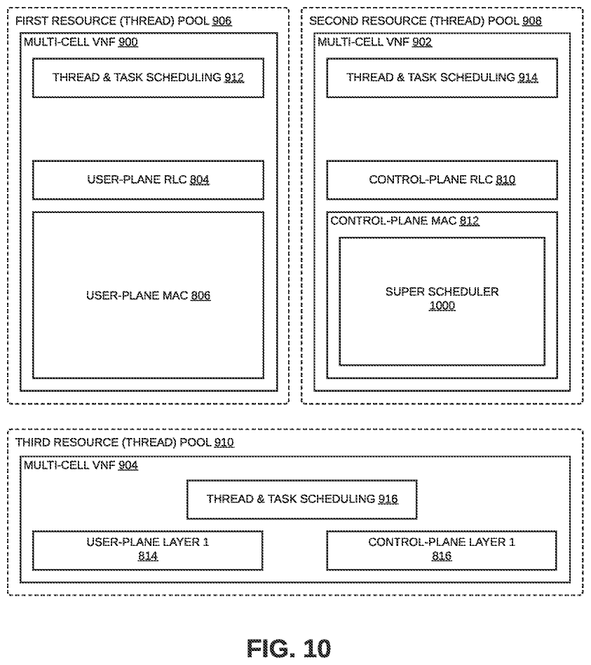

Also, although the coordination entity 126 and MAC schedulers 128 are described above as being implemented as separate entities, it is to be understood that other embodiments can be implemented in other ways. For example, as described below in connection with FIG. 10, the functions of the coordination entity 126 and MAC schedulers 128 can be combined into a single “super scheduler” entity that is configured to determine the resource needs for each served cell 102, determine a respective resource allocation for each served cell 102 based on the demand information for the multiple served cells 102, and schedule UEs 104 for each of the multiple served cells 102 with an objective of ensuring that the resource usage for each served cell 102 does not exceed that cell's resource allocation.

In the exemplary embodiment described here in connection with FIG. 1, the set of multi-cell VNFs 124 implements the DUs 108 for the served cells 102, and the baseband processing performed by the set of multi-cell VNFs 124 includes baseband processing for both Layer-2 and Layer-1 functions. In this exemplary embodiment, the set of multi-cell VNFs 124 includes one or more task scheduling functions 130, each of which is configured to ensure that the various tasks that make up the set of multi-cell VNFs 124 are scheduled for execution (using the threads and cores allocated to the associated cell 102) in accordance with the latency requirements required by the relevant air interface. For example, each task scheduling function 130 can be implemented using a task pooling framework such as the Intel BBUpooling framework, which can be used to breakdown one or more of the multi-cell VNFs 124 into appropriately sized tasks that can be executed in an appropriate series of chained tasks, executed in parallel where appropriate, and executed with appropriate priority using the allocated threads and cores.

In the exemplary embodiment described here in connection with FIG. 1, the set of multi-cell VNFs 124 are configured so that, when performing a user-plane operation, information about which of the multiple cells 102 that operation is being performed for is a part of the “context” of the operation (for example, the user-level context maintained for each UE 104 can include such cell information). As noted above, in this exemplary embodiment, a first subset of the multi-cell VNFs 124 perform Layer-2 processing for the multiple served cells 102 and a second subset of the multi-cell VNFs 124 perform Layer-1 processing for the multiple served cells 102. In that case, the interfaces provided between the Layer-2 multi-cell VNFs 124 and Layer-1 multi-cell VNFs 124 should be extensive enough for a receiving multi-cell VNF 124 to identify which cell 102 any received data is associated with. Also, in this example, multiple RUs 110 are used to serve a given single cell 102 and a given UE 104 can be served using a subset of one or more of the RUs 110, in which case the interfaces provided between the Layer-2 multi-cell VNFs 124 and Layer-1 multi-cell VNFs 124 should be extensive enough for a receiving multi-cell VNF 124 to identify which RUs 110 are used to server a given UE 104.

In the exemplary embodiment shown in FIG. 3, method 300 further comprises, determining if an overload condition exists for any multi-cell VNF 124 included in the set of multi-cell VNFs 124 in connection with performing the baseband processing necessary to provide the respective wireless service via any cell 102 (block 310) and, for each multi-cell VNF 124 and cell 102 for which an overload condition exists, reduce the respective usage of the one or more resources by that multi-cell VNF 124 in connection with performing the baseband processing necessary to provide the respective wireless service via that cell 102 (block 312). An overload condition exists for a multi-cell VNF 124 and cell 102 if the respective usage of the one or more resources by that multi-cell VNF 124 in connection with performing the baseband processing necessary to provide the respective wireless service via that cell 102 exceeds the respective allocation of the one or more resources for that cell 102.

For example, as shown in FIG. 1, one or more of the multi-cell VNFs 124 include an overload control function 132 that is configured to receive the resource allocation information for the multiple served cells 102 and monitor the amount of resources used by the associated multi-cell VNF 124 in performing the baseband processing for each of the multiple served cells 102. Each overload control function 132 is also configured to determine if the amount of resources used by the associated multi-cell VNF 124 in performing the baseband processing for any cell 102 exceeds the resource allocation for that cell 102 and, in response to such an overload condition existing, reduce the amount of resources used by the associated multi-cell VNF 124 in performing the baseband processing for that cell 102 (for example, by communicating with the relevant task scheduling function 130) so that the overload condition no longer exists.

This overload control function 132 (and blocks 310 and 312 of method 300) are optional and may be performed for some, none, or all of the multi-cell VNFs 124. This overload control can be used to address situations where, despite efforts to schedule UEs 104 for each cell 102 in a way that the resulting resource usage does not exceed that cell's resource allocation, the baseband processing being performed by a multi-cell VNF 124 for a given cell 102 ends up exceeding that cell's resource allocation. This is done to prevent an overload condition for one cell 102 from impacting the service provided to one or more of the other cells 102.

By using a multi-cell VNF approach to allocate resources, the issues associated with using a per-VNF to allocate resources can be avoided. In particular, changes to the resource allocations for each cell 102 can be made at the application-layer within the multi-cell VNFs 124 used to implement the various base station entities, thereby enabling such resource allocation changes to be made more quickly and more precisely than can be done by making resource allocations changes at the level of the general-purpose container or virtualization framework 122 and thereby enabling such resource allocation changes to be made “on the fly” without stopping and restarting the affected VNFs.

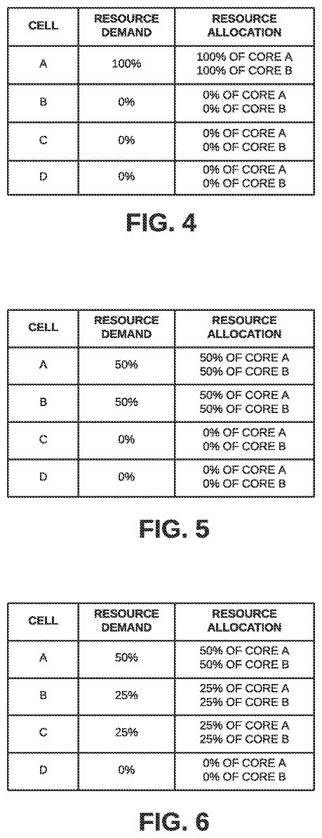

Examples of the operation of this multi-cell VNF approach are illustrated in FIGS. 4-7. In these examples, the resource that is allocated by the coordination entity 126 is the processing capacity provided by the processor cores of the physical nodes on which the DU 108 is implemented. In this example, the system 100 is configured and provisioned on the assumption that a “fully-loaded cell” requires two processor cores (individually referenced as core A and core B) in each physical node to handle the associated processing needs of each multi-cell VNF 124 instantiated to implement the DU 108 for the cell 102.

In the first three usage scenarios shown in FIGS. 4-6, the operator needs to serve four cells 102 (individually referenced as cell A, cell B, cell C, and cell D) that are loaded on average at 25 percent of the fully loaded cell capacity. As a result, with proper resource management, the system 100 should be able to serve the four cells 102 using physical nodes provisioned with two processor cores. Physical nodes provisioned with two processor cores should not only be able to handle four cells 102 all loaded at 25 percent of the fully loaded cell capacity but should also be able to handle various combinations of loads across the four cells 102 as long as the cumulative total load across all four cells 102 is less than or equal to the equivalent of one fully loaded cell 102.

A first usage scenario is shown in FIG. 4. In this first usage scenario, cell A is loaded at 100 percent of fully-loaded cell capacity, while cells B, C, and D are loaded at 0 percent. In response to this loading, the coordination entity 126 allocates 100 percent of the processing capacity of the two cores for performing baseband processing necessary to serve cell A and 0 percent of the processing capacity of the two cores for performing baseband processing necessary to serve each of cells B, C, and D.

A second usage scenario is shown in FIG. 5. In this second usage scenario, both cells A and B are loaded at 50 percent of fully-loaded cell capacity and cells C and D are loaded at 0 percent. In response to this loading, the coordination entity 126 allocates 50 percent of the processing capacity of the two cores for performing baseband processing necessary to serve each of cells A and B and 0 percent of the processing capacity of the two cores for performing baseband processing necessary to serve each of cells C and D.

A third usage scenario is shown in FIG. 6. In this third usage scenario, cell A is loaded at 50 percent of fully-loaded cell capacity, cells B and C are loaded at 25 percent of fully-loaded cell capacity, and cell D is loaded at 0 percent. In response to this loading, the coordination entity 126 allocates 50 percent of the processing capacity of the two cores for performing baseband processing necessary to serve cell A, 25 percent of the processing capacity of the two cores for performing baseband processing necessary to serve each of cells B and C, and 0 percent of the processing capacity of the two cores for performing baseband processing necessary to serve cell D.

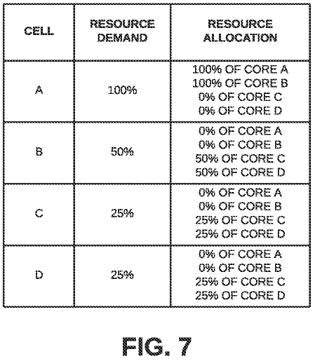

In a fourth usage scenario shown in FIG. 7, the operator needs to serve four cells 102 (individually referenced as cell A, cell B, cell C, and cell D) that are loaded on average at 50 percent of the fully loaded cell capacity. As a result, with proper resource management, the system 100 should be able to serve the four cells 102 with physical nodes provisioned with four processor cores. Physical nodes provisioned with four processor cores (individually referenced as core A, core B, core C, and core D) should not only be able to handle four cells 102 all loaded at 50 percent of the fully loaded cell capacity but should also be able to handle various combinations of loads across the four cells 102 as long as the cumulative total load across all four cells 102 is less than or equal to the equivalent of two fully loaded cells 102. For example, if cell A is loaded at 100 percent of fully-loaded cell capacity, cell B is loaded at 50 percent, and cells C and D are both loaded at 25 percent, the coordination entity 126 allocates 100 percent of the processing capacity of the first two cores for performing baseband processing necessary to serve cell A, 50 percent of the processing capacity of the second two cores for performing baseband processing necessary to serve cell B, and 25 percent of the processing capacity of the second two cores for performing baseband processing necessary to serve each of cells C and D.

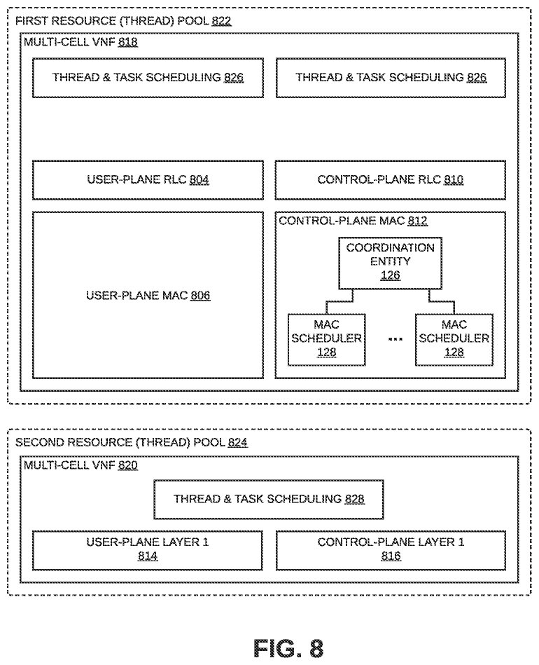

As noted above, the resources allocated to the set of multi-cell VNFs 124 by the general-purpose containerization or virtualization framework 122 can take the form of a set of one or more resource pools, where the set of resource pools can be configured in different ways. FIGS. 8-10 illustrate three different ways that the set of multi-cell VNFs 124 and resource pools can be configured. In the examples shown in FIGS. 8-10, the resources allocated to the multi-cell VNFs 124 by the general-purpose containerization or virtualization framework 122 comprises processor threads provided by the respective physical node on which each of the multi-cell VNFs 124 is executed.

In the examples shown in FIGS. 8-10, the user-plane Layer-2 functions implemented by the set of multi-cell VNFs 124 include a user-plane radio link control (RLC) function 804 configured to implement the user-plane RLC functions for the multiple cells 102, a user-plane media access control (MAC) function 806 configured to implement the user-plane MAC functions for the multiple cells 102. Also, in these examples, the control-plane Layer-2 functions implemented by the Layer-2 multi-cell VNF 124 include a control-plane RLC function 810 configured to implement the control-plane RLC functions for the multiple cells 102, a control-plane MAC function 812 configured to implement the control-plane MAC functions for the multiple cells 102 (including the MAC schedulers 128 for the cells 102). Moreover, in these examples, a single coordination entity 126 is implemented in the same multi-cell VNF 124 as the MAC schedulers 128 for the cells 102 (that is, the coordination entity 126 is implemented with the control-plane MAC function 812). In the examples shown in FIGS. 8-10, the set of multi-cell VNFs 124 also implements the user-plane and control-plane Layer-1 functions 814 and 816 performed by the DUs 108 for the multiple cells 102.

In the example shown in FIG. 8, the multi-cell VNFs 124 used to implement multiple DUs 108 for serving the multiple cells 102 can be partitioned into a first subset of the multi-cell VNFs 124 used to implement both the user-plane and control-plane Layer-2 functions for the multiple cells 102 and a second subset of the multi-cell VNFs 124 used to implement the user-plane and control-plane Layer-1 functions 814 and 816 for the multiple cells 102. More specifically, in this example, the Layer-2 subset comprises a single multi-cell VNF 818 that implements the user-plane and control-plane Layer-2 functions for the multiple cells 102, and the Layer-1 subset comprises a single multi-cell VNF 820 that implements the user-plane and control-plane Layer-1 functions 814 and 816 for the multiple cells 102 (though it is to be understood that in other embodiments one or both of the Layer-2 subset and Layer-1 subset can include multiple multi-cell VNFs).

In the example shown in FIG. 8, resources are allocated to the Layer-2 multi-cell VNF 818 from a first resource pool 822 (that is, from a first thread pool 822), and resources are allocated to the Layer-1 multi-cell VNF 820 from a second resource pool 824 (that is, from a second thread pool 824). In the example shown in FIG. 8, the Layer-2 multi-cell VNF 818 and the Layer-1 multi-cell VNF 820 each include a respective thread and task scheduling function 826 and 828.

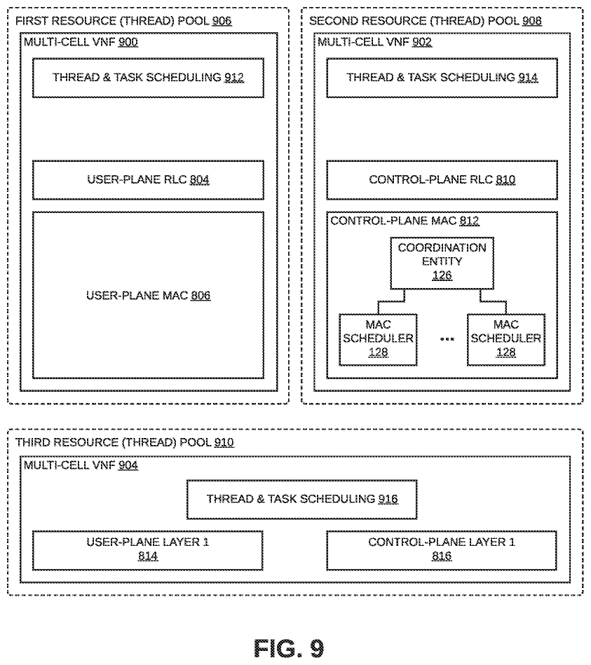

In the example shown in FIG. 9, one multi-cell VNF 900 is used to implement the user-plane Layer-2 functions for the multiple cells 102, a second multi-cell VNF 902 is used to implement the control-plane Layer-2 functions as well as the coordination entity 126, and a third multi-cell VNF 904 is used to implement the user-plane and control-plane Layer-1 functions 814 and 816 performed by the DUs 108 for the multiple cells 102.

In the example shown in FIG. 9, resources are allocated to the user-plane Layer-2 multi-cell VNF 900 from a first resource pool 906 (that is, from a first thread pool 906), resources are allocated to the control-plane Layer-2 multi-cell VNF 902 from a second resource pool 908 (that is, from a second thread pool 908), and resources are allocated to the Layer-1 multi-cell VNF 904 from a third resource pool 910 (that is from a third thread pool 910). In the example shown in FIG. 9, the user-plane Layer-2 multi-cell VNF 900, the control-plane Layer-2 multi-cell VNF 902, and the Layer-1 multi-cell VNF 904 each include a respective thread and task scheduling function 912, 914, and 916.

In the examples shown in FIGS. 8 and 9, the control-plane Layer-2 functions implement a separate single coordination entity 126 and a separate MAC scheduler 128 for each served cell. The example shown in FIG. 10 is similar to the example shown in FIG. 9 except that in the example shown in FIG. 10, the functions described above as being performed by the MAC schedulers 128 and the coordination entity 126 are integrated into a single “super scheduler” function 1000. That is, a single entity (the super scheduler function 1000) determines the resource needs for each served cell 102, determines a respective resource allocation for each served cell 102 based on the demand information for the multiple served cells 102, and schedules UEs 104 for each of the multiple served cells 102 with an objective of ensuring that the resource usage for each served cell 102 does not exceed that cell's resource allocation. By performing all of these functions in a single entity, it is likely that the resource allocation and scheduling decisions can be made in a way that reacts more quickly to changes in demand and that uses resources more efficiently, with the possible trade off of increased implementation complexity.

Other embodiments can be implemented in other ways. Additionally, the multicell VNF techniques described with respect to FIGS. 8-10 can be used in implementing the CU-CP and CU-UP functions of FIG. 1.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be performed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random-access memory. Storage devices suitable for tangibly embodying computer program instructions and data include all forms of non-volatile memory, including by way of example semiconductor memory devices, such as erasable programmable read-only memory (EPROM), electrically-erasable programmable read-only memory (EEPROM), and flash memory devices; magnetic disks such as internal hard disks and removable disks; magneto-optical disks; and digital video disks (DVDs). Any of the foregoing may be supplemented by, or incorporated in, specially-designed application-specific integrated circuits (ASICs).

### EXAMPLE EMBODIMENTS

Example 1 includes a system to provide wireless service to user equipment (UEs), the system comprising: a scalable cloud environment configured to execute a set of multi-cell virtual network functions (VNFs) configured to natively perform baseband processing necessary to provide wireless service to the UEs using multiple cells using one or more resources; wherein the set of multi-cell VNFs is configured to: determine respective demand information for each cell that is indicative of a respective demand for the one or more resources in connection with serving that cell; determine a respective allocation of the one or more resources for each cell based on the demand information for the multiple cells; and for each cell: perform scheduling of the respective UEs for that cell with an objective of ensuring that a respective demand for the one or more resources in connection with serving that cell does not exceed a capacity associated with the respective allocation of the one or more resources for that cell; and perform baseband processing necessary to provide respective wireless service via that cell in accordance with the scheduling for that cell.

Example 2 includes the system of Example 1, wherein the set of multi-cell VNFs is further configured to: determine if an overload condition exists for any multi-cell VNF included in the set of multi-cell VNFs in connection with performing the baseband processing necessary to provide the respective wireless service via any cell; and for each multi-cell VNF and cell for which an overload condition exists, reduce the respective usage of the one or more resources by that multi-cell VNF in accordance with a portion of the respective demand for the one or more resources allocated for that cell for which the overload condition exists.

Example 3 includes the system of any of Examples 1-2, wherein the set of multi-cell VNFs comprises at least one multi-cell VNF that is configured to implement: a media access control (MAC) scheduler function for each cell; and one or more coordination entities; wherein the respective MAC scheduler function is configured to determine, for each cell, the respective demand information for that cell and communicate the respective demand information for that cell to each of the one or more coordination entities; wherein the one or more coordination entities are configured to determine the respective allocation of the one or more resources for each cell based on the demand information for the multiple cells and communicate the respective allocation of the one or more resources for that cell to the MAC scheduler function for that cell; and wherein the MAC scheduler function is configured to, for each of the cells, perform the scheduling of the respective UEs for that cell with the objective of ensuring that the respective demand for the one or more resources in connection with serving that cell does not exceed the capacity associated with the respective allocation of the one or more resources for that cell.

Example 4 includes the system of Example 3, wherein the one or more coordination entities comprises one of: a single coordination entity that is configured to determine the respective demand information for each cell; and a plurality of coordination entities, each cell having an associated respective coordination entity that is configured to determine the respective demand information for that cell.

Example 5 includes the system of any of Examples 1-4, wherein the set of multi-cell VNFs comprises at least one multi-cell VNF that is configured to implement a super scheduler entity; wherein the super scheduler entity is configured to determine the respective demand information for each cell; wherein the super scheduler entity is configured to determine the respective allocation of the one or more resources for each cell based on the demand information for the multiple cells; and wherein the super scheduler entity is configured to, for each of the cells, perform the scheduling of the respective UEs for that cell with the objective of ensuring that the respective demand for the one or more resources in connection with serving that cell does not exceed the capacity associated with the respective allocation of the one or more resource for that cell.

Example 6 includes the system of any of Examples 1-5, wherein at least one multi-cell VNF included in the set of multi-cell VNFs comprises a task scheduling function that is configured to schedule tasks implemented by that multi-cell VNF with an objective of ensuring that one or more latency requirements are met.

Example 7 includes the system of any of Examples 1-6, wherein the system comprises at least one remote unit (RU), wherein each RU is used to serve at least one of the cells and is communicatively coupled to the scalable cloud environment, wherein each RU is associated with a respective set of one or more antennas via which downlink radio frequency signals are radiated to at least some of the UEs and via which uplink radio frequency signals transmitted by at least some of the UEs are received.

Example 8 includes the system of Example 7, wherein the set of multi-cell VNFs are configured to implement, for each cell, a respective distributed unit (DU) to serve that cell, each DU implements Layer-2 functions and some Layer-1 functions for the respective cell served by that DU; and wherein each RU is configured to implement, for each cell served by that RU, any Layer-1 functions not implemented by the DU for that cell and radio frequency (RF) functions.

Example 9 includes the system of any of Examples 7-8, wherein at least some of the cells are served by multiple RUs.

Example 10 includes the system of any of Examples 1-9, wherein the one or more resources comprises a set of resource pools, each resource pool comprising one or more types of resources.

Example 11 includes the system of Example 10, wherein each of the set of resource pools is either dedicated to a single one of the multi-cell VNFs or shared among two or more of the multi-cell VNFs.

Example 12 includes the system of any of Examples 1-11, wherein the one or more resources comprises at least one of processing resources, communication resources, and storage resources.

Example 13 includes the system of any of Examples 1-12, wherein the respective demand information for each cell comprises information about one or more of: a respective number of active UEs, a respective number of connected UEs, a respective number of scheduled UEs per transmission time interval (TTI), a respective throughput, respective coding rates used, a respective carrier bandwidth, a respective number of constituent carriers used, respective modulation modes used, a respective sub-carrier spacing used, a respective duplexing mode used, a respective slot format used, respective transmission ranks used, a respective number physical resource blocks (PRBs) communicated, a respective bit rate, and a respective number of packets per second.

Example 14 includes the system of any of Examples 1-13, wherein the respective demand information for each cell is determined, at least in part, by at least one entity not implemented by the set of multi-cell VNFs.

Example 15 includes the system of any of Examples 1-14, wherein the respective demand information for each cell is determined, at least in part, by a radio access network (RAN) intelligent controller (RIC).

Example 16 includes the system of any of Examples 1-15, wherein the respective allocation of the one or more resources for each cell is determined, at least in part, by at least one entity not implemented by the set of multi-cell VNFs.

Example 17 includes the system of any of Examples 1-16, wherein the respective allocation of the one or more resources for each cell is determined, at least in part, by a radio access network (RAN) intelligent controller (RIC).

Example 18 includes a method of providing wireless service to user equipment (UEs) using a scalable cloud environment configured to execute a set of multi-cell virtual network functions (VNFs) configured to natively perform baseband processing necessary to provide wireless service to the UEs using multiple cells using one or more resources, the method comprising: determining respective demand information for each cell that is indicative of a respective demand for the one or more resources in connection with serving that cell; determining a respective allocation of the one or more resources for each cell based on the demand information for the multiple cells; and for each cell: performing scheduling of the respective UEs for that cell with an objective of ensuring that a respective demand for the one or more resources in connection with serving that cell does not exceed a capacity associated with the respective allocation of the one or more resources for that cell; and performing baseband processing necessary to provide respective wireless service via that cell in accordance with the scheduling for that cell.

Example 19 includes the method of Example 18, wherein the method further comprising: determining if an overload condition exists for any multi-cell VNF included in the set of multi-cell VNFs in connection with performing the baseband processing necessary to provide the respective wireless service via any cell; and for each multi-cell VNF and cell for which an overload condition exists, reducing the respective usage of the one or more resources by that multi-cell VNF in accordance with a portion of the respective demand for the one or more resources allocated for that cell for which the overload condition exists.

Example 20 includes the method of any of Examples 18-19, wherein the set of multi-cell VNFs comprises at least one multi-cell VNF that is configured to implement: a media access control (MAC) scheduler function for each cell; and one or more coordination entities; wherein the respective MAC scheduler function is configured to determine, for each cell, the respective demand information for that cell and communicate the respective demand information for that cell to each of the one or more coordination entities; wherein the one or more coordination entities are configured to determine the respective allocation of the one or more resources for each cell based on the demand information for the multiple cells and communicate the respective allocation of the one or more resources for that cell to the MAC scheduler function for that cell; and wherein the MAC scheduler function is configured to, for each of the cells, perform the scheduling of the respective UEs for that cell with the objective of ensuring that the respective demand for the one or more resources in connection with serving that cell does not exceed the capacity associated with the respective allocation of the one or more resources for that cell.

Example 21 includes the method of Example 20, wherein the one or more coordination entities comprises one of: a single coordination entity that is configured to determine the respective demand information for each cell; and a plurality of coordination entities, each cell having an associated respective coordination entity that is configured to determine the respective demand information for that cell.

Example 22 includes the method of any of Examples 18-21, wherein the set of multi-cell VNFs comprises at least one multi-cell VNF that is configured to implement a super scheduler entity; wherein the super scheduler entity is configured to determine the respective demand information for each cell; wherein the super scheduler entity is configured to determine the respective allocation of the one or more resources for each cell based on the demand information for the multiple cells; and wherein the super scheduler entity is configured to, for each of the cells, perform the scheduling of the respective UEs for that cell with the objective of ensuring that the respective demand for the one or more resources in connection with serving that cell does not exceed the capacity associated with the respective allocation of the one or more resources for that cell.

Example 23 includes the method of any of Examples 18-22, wherein at least one multi-cell VNF included in the set of multi-cell VNFs comprises a task scheduling function that is configured to schedule tasks implemented by that multi-cell VNF with an objective of ensuring that one or more latency requirements are met.

Example 24 includes the method of any of Examples 18-23, wherein at least one remote unit (RU) is used to provide the wireless service to the UEs using the multiple cells, wherein each RU is used to serve at least one of the cells and is communicatively coupled to the scalable cloud environment, wherein each RU is associated with a respective set of one or more antennas via which downlink radio frequency signals are radiated to at least some of the UEs and via which uplink radio frequency signals transmitted by at least some of the UEs are received.

Example 25 includes the method of Example 24, wherein the set of multi-cell VNFs are configured to implement, for each cell, a respective distributed unit (DU) to serve that cell, each DU implements Layer-2 functions and some Layer-1 functions for the respective cell served by that DU; and wherein each RU is configured to implement, for each cell served by that RU, any Layer-1 functions not implemented by the DU for that cell and radio frequency (RF) functions.

Example 26 includes the method of any of Examples 24-25, wherein at least some of the cells are served by multiple RUs.

Example 27 includes the method of any of Examples 18-26, wherein the one or more resources comprises a set of resource pools, each resource pool comprising one or more types of resources.

Example 28 includes the method of Example 27, wherein each of the set of resource pools is either dedicated to a single one of the multi-cell VNFs or shared among two or more of the multi-cell VNFs.

Example 29 includes the method of any of Examples 18-28, wherein the one or more resources comprises at least one of processing resources, communication resources, and storage resources.

Example 30 includes the method of any of Examples 18-29, wherein the respective demand information for each cell comprises information about one or more of: a respective number of active UEs, a respective number of connected UEs, a respective number of scheduled UEs per transmission time interval (TTI), a respective throughput, respective coding rates used, a respective carrier bandwidth, a respective number of constituent carriers used, respective modulation modes used, a respective sub-carrier spacing used, a respective duplexing mode used, a respective slot format used, respective transmission ranks used, a respective number physical resource blocks (PRBs) communicated, a respective bit rate, and a respective number of packets per second.

Example 31 includes the method of any of Examples 18-30, wherein the respective demand information for each cell is determined, at least in part, by at least one entity not implemented by the set of multi-cell VNFs.

Example 32 includes the method of any of Examples 18-31, wherein the respective demand information for each cell is determined, at least in part, by a radio access network (RAN) intelligent controller (RIC).

Example 33 includes the method of any of Examples 18-32, wherein the respective allocation of the one or more resources for each cell is determined, at least in part, by at least one entity not implemented by the set of multi-cell VNFs.

Example 34 includes the method of any of Examples 18-33, wherein the respective allocation of the one or more resources for each cell is determined, at least in part, by a radio access network (RAN) intelligent controller (RIC).

A number of embodiments of the invention defined by the following claims have been described. Nevertheless, it will be understood that various modifications to the described embodiments may be made without departing from the spirit and scope of the claimed invention. Accordingly, other embodiments are within the scope of the following claims.

What is claimed is:

1. A system to provide wireless service to user equipment (UEs), the system comprising:
a scalable cloud environment configured to execute a set of multi-cell virtual network functions (VNFs) configured to natively perform baseband processing necessary to provide wireless service to the UEs using multiple cells using one or more resources;
wherein the set of multi-cell VNFs is configured to:
determine respective demand information for each cell that is indicative of a respective demand for the one or more resources in connection with serving that cell;
determine a respective allocation of the one or more resources for each cell based on the demand information for the multiple cells; and
for each cell:
perform scheduling of respective UEs for that cell with an objective of ensuring that a respective demand for the one or more resources in connection with serving that cell does not exceed a capacity associated with the respective allocation of the one or more resources for that cell; and
perform baseband processing necessary to provide respective wireless service via that cell in accordance with the scheduling for that cell.

2. The system of claim 1, wherein the set of multi-cell VNFs is further configured to:
determine if an overload condition exists for any multi-cell VNF included in the set of multi-cell VNFs in connection with performing the baseband processing necessary to provide the respective wireless service via any cell; and
for each multi-cell VNF and cell for which an overload condition exists, reduce the respective usage of the one or more resources by that multi-cell VNF in accordance with a portion of the respective demand for the one or more resources allocated for that cell for which the overload condition exists.

3. The system of claim 1, wherein the set of multi-cell VNFs comprises at least one multi-cell VNF that is configured to implement:
a respective media access control (MAC) scheduler function for each cell; and
one or more coordination entities;
wherein the respective MAC scheduler function is configured to determine, for each cell, the respective demand information for that cell and communicate the respective demand information for that cell to each of the one or more coordination entities;
wherein the one or more coordination entities are configured to determine the respective allocation of the one or more resources for each cell based on the demand information for the multiple cells and communicate the respective allocation of the one or more resources for that cell to the respective MAC scheduler function for that cell; and
wherein the respective MAC scheduler function is configured to, for each of the cells, perform the scheduling of the respective UEs for that cell with the objective of ensuring that the respective demand for the one or more resources in connection with serving that cell does not exceed the capacity associated with the respective allocation of the one or more resources for that cell.

4. The system of claim 3, wherein the one or more coordination entities comprises one of:
a single coordination entity that is configured to determine the respective demand information for each cell; and
a plurality of coordination entities, each cell having an associated respective coordination entity that is configured to determine the respective demand information for that cell.

5. The system of claim 1, wherein the set of multi-cell VNFs comprises at least one multi-cell VNF that is configured to implement a super scheduler entity;
wherein the super scheduler entity is configured to determine the respective demand information for each cell;
wherein the super scheduler entity is configured to determine the respective allocation of the one or more resources for each cell based on the demand information for the multiple cells; and
wherein the super scheduler entity is configured to, for each of the cells, perform the scheduling of the respective UEs for that cell with the objective of ensuring that the respective demand for the one or more resources in connection with serving that cell does not exceed the respective capacity associated with the allocation of the one or more resources for that cell.

6. The system of claim 1, wherein at least one multi-cell VNF included in the set of multi-cell VNFs comprises a task scheduling function that is configured to schedule tasks implemented by that multi-cell VNF with an objective of ensuring that one or more latency requirements are met.

7. The system of claim 1, wherein the system comprises at least one remote unit (RU), wherein each RU is used to serve at least one of the cells and is communicatively coupled to the scalable cloud environment, wherein each RU is associated with a respective set of one or more antennas via which downlink radio frequency signals are radiated to at least some of the UEs and via which uplink radio frequency signals transmitted by at least some of the UEs are received.

8. The system of claim 7, wherein the set of multi-cell VNFs are configured to implement, for each cell, a respective distributed unit (DU) to serve that cell, each DU implements Layer-2 functions and some Layer-1 functions for the respective cell served by that DU; and
wherein each RU is configured to implement, for each cell served by that RU, any Layer-1 functions not implemented by the DU for that cell and radio frequency (RF) functions.

9. The system of claim 1, wherein the respective demand information for each cell comprises information about one or more of: a respective number of active UEs, a respective number of connected UEs, a respective number of scheduled UEs per transmission time interval (TTI), a respective throughput, respective coding rates used, a respective carrier bandwidth, a respective number of constituent carriers used, respective modulation modes used, a respective sub-carrier spacing used, a respective duplexing mode used, a respective slot format used, respective transmission ranks used, a respective number physical resource blocks (PRBs) communicated, a respective bit rate, and a respective number of packets per second.

10. The system of claim 1, wherein the respective demand information for each cell is determined, at least in part, by a radio access network (RAN) intelligent controller (RIC).

11. The system of claim 1, wherein the respective allocation of the one or more resources for each cell is determined, at least in part, by at least one entity not implemented by the set of multi-cell VNFs.

12. A method of providing wireless service to user equipment (UEs) using a scalable cloud environment configured to execute a set of multi-cell virtual network functions (VNFs) configured to natively perform baseband processing necessary to provide wireless service to the UEs using multiple cells using one or more resources, the method comprising:
determining respective demand information for each cell that is indicative of a respective demand for the one or more resources in connection with serving that cell;
determining a respective allocation of the one or more resources for each cell based on the demand information for the multiple cells; and
for each cell:
performing scheduling of the respective UEs for that cell with an objective of ensuring that a respective demand for the one or more resources in connection with serving that cell does not exceed a capacity associated with the respective allocation of the one or more resources for that cell; and
performing baseband processing necessary to provide respective wireless service via that cell in accordance with the scheduling for that cell.

13. The method of claim 12, wherein the method further comprising:
determining if an overload condition exists for any multi-cell VNF included in the set of multi-cell VNFs in connection with performing the baseband processing necessary to provide the respective wireless service via any cell; and
for each multi-cell VNF and cell for which an overload condition exists, reducing the respective usage of the one or more resources by that multi-cell VNF in accordance with a portion of the respective demand for the one or more resources allocated for that cell for which the overload condition exists.

14. The method of claim 12, wherein the set of multi-cell VNFs comprises at least one multi-cell VNF that is configured to implement:
a respective media access control (MAC) scheduler function for each cell; and
one or more coordination entities;
wherein the respective MAC scheduler function is configured to determine, for each cell, the respective demand information for that cell and communicate the respective demand information for that cell to each of the one or more coordination entities;
wherein the one or more coordination entities are configured to determine the respective allocation of the one or more resources for each cell based on the demand information for the multiple cells and communicate the respective allocation of the one or more resources for that cell to the respective MAC scheduler function for that cell; and
wherein the respective MAC scheduler function is configured to, for each of the cells, perform the scheduling of the respective UEs for that cell with the objective of ensuring that the respective demand for the one or more resources in connection with serving that cell does not exceed the respective allocation of the capacity associated with the one or more resources for that cell.

15. The method of claim 14, wherein the one or more coordination entities comprises one of:
a single coordination entity that is configured to determine the respective demand information for each cell; and
a plurality of coordination entities, each cell having an associated respective coordination entity that is configured to determine the respective demand information for that cell.

16. The method of claim 12, wherein the set of multi-cell VNFs comprises at least one multi-cell VNF that is configured to implement a super scheduler entity;
wherein the super scheduler entity is configured to determine the respective demand information for each cell;
wherein the super scheduler entity is configured to determine the respective allocation of the one or more resources for each cell based on the demand information for the multiple cells; and
wherein the super scheduler entity is configured to, for each of the cells, perform the scheduling of the respective UEs for that cell with the objective of ensuring that the respective demand for the one or more resources in connection with serving that cell does not exceed the capacity associated with the respective allocation of the one or more resources for that cell.

17. The method of claim 12, wherein at least one multi-cell VNF included in the set of multi-cell VNFs comprises a task scheduling function that is configured to schedule tasks implemented by that multi-cell VNF with an objective of ensuring that one or more latency requirements are met.

18. The method of claim 12, wherein at least one remote unit (RU) is used to provide the wireless service to the UEs using the multiple cells, wherein each RU is used to serve at least one of the cells and is communicatively coupled to the scalable cloud environment, wherein each RU is associated with a respective set of one or more antennas via which downlink radio frequency signals are radiated to at least some of the UEs and via which uplink radio frequency signals transmitted by at least some of the UEs are received.

19. The method of claim 18, wherein the set of multi-cell VNFs are configured to implement, for each cell, a respective distributed unit (DU) to serve that cell, each DU implements Layer-2 functions and some Layer-1 functions for the respective cell served by that DU; and
wherein each RU is configured to implement, for each cell served by that RU, any Layer-1 functions not implemented by the DU for that cell and radio frequency (RF) functions.

20. The method of claim 12, wherein the respective demand information for each cell comprises information about one or more of: a respective number of active UEs, a respective number of connected UEs, a respective number of scheduled UEs per transmission time interval (TTI), a respective throughput, respective coding rates used, a respective carrier bandwidth, a respective number of constituent carriers used, respective modulation modes used, a respective sub-carrier spacing used, a respective duplexing mode used, a respective slot format used, respective transmission ranks used, a respective number physical resource blocks (PRBs) communicated, a respective bit rate, and a respective number of packets per second.
